(19) United States
(12) Patent Application Publication
(10) Pub. No.: US 2023/0225381 A1
(43) Pub. Date: Jul. 20, 2023

(54) FLAVOR PARTICLE

(71) Applicant: Firmenich SA, Satigny (CH)

(72) Inventors: Pierre-Etienne BOUQUERAND, Satigny (CH); Yves DIEULESAINT, Satigny (CH); Yannick CRETIGNIER, Satigny (CH); Sandrine JOUHET, Satigny (CH); Frederic CHABERT, Satigny (CH); Stéphanie PIOTTON, Satigny (CH)

(21) Appl. No.: 18/000,623

(22) PCT Filed: May 31, 2021
(86) PCT No.: PCT/EP2021/064539

§ 371 Date: Dec. 2, 2022

(30) Foreign Application Priority Data
Jun. 2, 2020 (EP) 20177838.8

(51) Int. Cl. A23L 27/00; A23L 29/219

(52) U.S. Cl. CPC A23L 27/72; A23L 27/88; A23L 29/219

(57) ABSTRACT

The present invention relates to the field of flavoring. More particularly, the present invention relates to an encapsulated flavor particle that has a high flavor load, a flavored consumer product comprising the same. The present invention also relates to a process for preparing an encapsulated flavor particle having a high flavor load.

### TECHNICAL FIELD

The present invention relates to the field of flavoring. More particularly, the present invention relates to an encapsulated flavor particle that has a high flavor load, a flavored consumer product comprising the same. The present invention also relates to a process for preparing an encapsulated flavor particle.

### BACKGROUND OF THE INVENTION

The consumer’s demand for flavor delivery systems is more and more important and is driving the development of new delivery systems.

Flavor delivery systems in form of particles are commonly used in the field of flavoring because they are easy to dose, handle and prepare.

Flavor delivery systems can be prepared by different well-known techniques such as spray-drying or screw extrusion to encapsulate liquid and powder flavors in a carbohydrate carrier.

A limitation of melt extrusion is the low retained flavor load which is typically less than 10% by weight and will highly depends on the volatility of the flavors to encapsulate.

In many applications, high flavor intensity is required, and such a low flavor load is not cost effective in use.

It would be therefore desirable to have a high flavor load in an extruded particle.

The present invention provides a solution to the above-mentioned problems.

### SUMMARY

A first object of the invention is a particle comprising:
a flavor, and
a carrier material
characterized in that:
the carrier material comprises at least one modified starch and at least one hydrolyzed starch,
the hydrolyzed starch has a DE greater than 6DE, and
the particle comprises greater than or equals to 13% by weight of flavor based on the total weight of the particle.

A second object of the invention is a process for preparing an extruded particle, wherein it comprises the following steps:
a) mixing at least a carrier material and a plasticizer, preferably water, to form a mixture;
b) heating the mixture at a temperature sufficient to form a molten mass;
c) pumping the molten mass and pushing said molten mass through a static mixer;
d) extruding the melt through a die to form an extrudate;
e) cutting or crushing the extrudate to form an extruded particle,
wherein a flavor is added to the mixture in step a) and/or in the molten mass in step b).

A third object of the invention is a flavored consumer product comprising the flavor particle as described herein-above and, optionally, a flavor base consumer product.

### DETAILED DESCRIPTION

### Flavor Particle

The present invention relates to a particle comprising:
a flavor, and
a carrier material
   characterized in that:
      the carrier material comprises at least one modified starch and at least one hydrolyzed starch,
      the hydrolyzed starch has a DE greater than 6DE, and
      the particle comprises greater than or equals to 13% by weight of flavor based on the total weight of the particle.

In a particular embodiment, the flavor particle according to the present invention is an amorphous particle.

In a particular embodiment, the flavor particle according to the present invention is an extruded particle.

In a particular embodiment, the flavor particle has a glass transition temperature of equal to or greater than 25° C., preferably equal to or greater than 30° C. and more preferably equal to or greater than 40° C. In a particular embodiment, the flavor particle has a glass transition temperature of equal to or less than 120° C., preferably equal to or less than 100° C. and more preferably equal to or less than 90° C. In a particular embodiment, the flavor particle has a glass transition temperature greater than 25° C. and less than 120° C., preferably greater than 35° C. and less than 100° C. and more preferably 40° C. to 90° C. The glass transition temperature can be measured by standard methods known by a skilled person such as by using a differential scanning calorimeter DSC822e (Mettler).

In a particular embodiment, the flavor particle is in a solid, granular state.

In a particular embodiment, the flavor particle is free-flowing.

In a particular embodiment, the flavor particle has an average particle size of equal to or greater than 30 µm and preferably equal to or greater than 50 µm. In a particular embodiment, the flavor particle as an average particle size of equal to or less than 5000 µm, preferably equal to or less than 3000 µm, more preferably equal to or less than 2000 µm and even more preferably equal to or less than 1000 µm. In a particular embodiment, the flavor particle has an average particle size of 30 to 5000 µm, preferably 250 to 2500 µm. The average particle size can be measured by standard methods known by a skilled person such as by using Beckman Coulter Laser Diffraction Particle Size Analyzer (Coulter LS 13320) with Tornado Dry Powder Module (Beckman Coulter Inc., Miami, FL). The average particle size can be also determined by sieving.

The particle or flavor particle according to the present invention comprises a flavor dispersed within the carrier material.

### Flavor

By “flavor or flavoring composition”, it is meant here a flavoring ingredient or a mixture of flavoring ingredients, solvents or adjuvants of current use for the preparation of a flavoring formulation, i.e. a particular mixture of ingredients which is intended to be added to an edible composition or chewable product to impart, improve or modify its organoleptic properties, in particular its flavor and/or taste. Flavoring ingredients are well known to a person skilled in the art and their nature does not warrant a detailed description here, which in any case would not be exhaustive, the skilled flavorist being able to select them on the basis of his general knowledge and according to the intended use or application and the organoleptic effect it is desired to achieve. Many of these flavoring ingredients are listed in reference texts such as in the book by S. Arctander, Perfume and Flavor Chemicals, 1969, Montclair, N.J., USA, or its more recent versions, or in other works of similar nature such as Fenaroli’s Handbook of Flavor Ingredients, 1975, CRC Press or Synthetic Food Adjuncts, 1947, by M. B. Jacobs, van Nostrand Co., Inc. Solvents and adjuvants of current use for the preparation of a flavoring formulation are also well known in the art.

In a particular embodiment, the flavor is a mint flavor. In a more particular embodiment, the mint is selected from the group consisting of peppermint and spearmint.

In a further embodiment, the flavor is a cooling agent or mixtures thereof.

In another embodiment, the flavor is a menthol flavor.

Flavors that are derived from or based on fruits where citric acid is the predominant, naturally-occurring acid include but are not limited to, for example, citrus fruits (e.g. lemon, lime), limonene, strawberry, orange, and pineapple. In one embodiment, the flavors food is lemon, lime or orange juice extracted directly from the fruit. Further embodiments of the flavor comprise the juice or liquid extracted from oranges, lemons, grapefruits, key limes, citrons, clementines, mandarins, tangerines, and any other citrus fruit, or variation or hybrid thereof. In a particular embodiment, the flavor comprises a liquid extracted or distilled from oranges, lemons, grapefruits, key limes, citrons, clementines, mandarins, tangerines, any other citrus fruit or variation or hybrid thereof, pomegranates, kiwifruits, watermelons, apples, bananas, blueberries, melons, ginger, bell peppers, cucumbers, passion fruits, mangos, pears, tomatoes, and strawberries.

In a particular embodiment, the flavor comprises a composition that comprises limonene, in a particular embodiment, the composition is a citrus that further comprises limonene.

In another particular embodiment, the flavor comprises a flavor selected from the group comprising strawberry, orange, lime, tropical, berry mix, and pineapple.

The phrase flavor includes not only flavors that impart or modify the smell of foods but include taste imparting or modifying ingredients. The latter do not necessarily have a taste or smell themselves but are capable of modifying the taste that other ingredients provides, for instance, salt enhancing ingredients, sweetness enhancing ingredients, umami enhancing ingredients, bitterness blocking ingredients and so on.

In a further embodiment, suitable sweetening components may be included in the particles described herein. In a particular embodiment, a sweetening component is selected from the group consisting of sugar (e.g., but not limited to sucrose), a stevia component (such as but not limited to stevioside or rebaudioside A), sodium cyclamate, aspartame, sucralose, sodium saccharine, and Acesulfam K or mixtures thereof.

In a particular embodiment, the flavor particle comprises a flavor in an amount greater than 13 wt.% (based on the total weight of the flavor particle).

In a particular embodiment, the flavor particle comprises a flavor in an amount of equal to or greater than 15 wt.% (based on the total weight of the flavor particle). In a particular embodiment, the flavor particle comprises a flavor in an amount of equal to or less than 40 wt.% and particularly equal to or less than 30 wt.%, and more particularly equal to or less than 25 wt.% (based on the total weight of the flavor particle). In a particular embodiment, the flavor particle comprises the flavor in an amount of 13 to 40 wt.%, particularly between 13 to 30 wt.%, more particularly between 13 to 25 wt.% (based on the total weight of the flavor particle).

In a particular embodiment, the flavor particle comprises a flavor in an amount between 13 to 20%, particularly between 13 to 15% wt.% (based on the total weight of the flavor particle).

In a particular embodiment, the flavor particle comprises the flavor in an amount of 15 to 40 wt.%, particularly of 15 to 30 wt.% and more particularly of 15 to 25 wt.% (based on the total weight of the flavor particle).

### Carrier Material of the Flavor Particle

According to the invention, the carrier material of the flavor particle comprises at least one hydrolyzed starch having a DE greater than 6DE, particularly greater than 10DE, more particularly greater than 17DE.

The DE value is a measure of the reducing equivalent of hydrolyzed starch, referenced to dextrose and expressed as a percentage (based on dry matter), determined by well-known procedures.

The dextrose equivalent DE is typically defined by the following relationship (H. Levine, L. Slade: “Water as a plasticizer: physico-chemical aspects of low moisture polymeric systems” :, in Water Science Reviews, 1988, Vol. 3, F. Franks (Ed.), pp. 79-185, Cambridge University Press, Cambridge, England)

$$\text{DE} = \left(18016\right) \text{/Mn}$$

wherein DE is Dextrose equivalent and wherein Mn is number average molecular weight.

The value Mn can be easily determined by the person skilled in the art, for example by using SEC Multi-Detector System.

As non-limiting example, the SEC instrument is the Viscotek TDA305 max system (Malvern Instruments, Ltd, UK) with Viscotek Triple Detector Array (TDA) incorporating Refractive Index (RI), Light Scattering (LS), and Viscosity (VS) detectors. A typical method to determine Mn would be the following: the chromatographic system consists of A2000 (CLM3015) and A6000 (CLM3020) (300 mm L × 8.0 mm ID, Malvern Instruments Ltd.) put in series after a A7 guard column, with claimed exclusion limits for pullulan of 4 KDa and 2000 KDa respectively. The eluent is 0.1 M sodium nitrate with a flow rate of 0.4 mL/min. The injected volume is 100 µL with sample concentration of around 2 mg/mL. All measurements were conducted at 35° C. Reproducibility of the method is acceptable with standard deviation of 0.06% on retention volume at peak maximum for three consecutive injections.

The term “hydrolyzed starch” means an oligosaccharide-type material typically obtained by acid and / or enzymatic hydrolysis of starch, preferably corn starch.

According to a particular embodiment, the hydrolyzed starch is chosen in the group consisting of maltodextrins, dextrins, corn syrup and mixture thereof.

According to the invention, the carrier material comprises also a modified starch.

The term “modified starch” has the normal meaning of the term to a person skilled in the art, i.e a starch that has been physically modified (physical modification), enzymatically modified (enzymatic modification) or chemically modified (chemical modification).

“Physically modified starch” means a starch which has been subjected to a heat treatment in the presence of relatively small amounts of water or moisture. No other reagents are added to the starch during the heat treatment. The heat-treatment processes include heat-moisture and annealing treatments, both of which cause a physical modification of starch without any gelatinization.

“Enzymatically modified starch” means a starch which has been treated with one or more enzymes to modify its properties.

“Chemically modified starch” means a starch which has been reacted with reagents which have been added to the starch in order to form new covalent bonds between those molecules and the starch molecules.

Particular examples of modified starches comprise dextrin, hydroxypropylated starch, phosphate starch phosphate, octenylsuccinated starch, starch aluminium octenyl succinate, acetylated distarch phosphate, acetylated distarch adipate, acetylated distarch adipate, hydroxypropyl distarch phosphate and acetylated oxidized starch. Some non-limited examples include octenylsuccinic anhydride-modified starches such as MiraCap® by Tate & Lyle, Capsul® by Ingredion, EmCap® by Cargill, etc.

According to an embodiment, the modified starch is a chemically modified starch. The chemical modification can increase notably its hydrophobicity to act as stabilizer and emulsifier.

According to this embodiment, the chemically modified starch is chosen in the group consisting of octenyl succinated starches.

According to a particular embodiment, the modified starch is not agglomerated or compressed.

According to an embodiment, the modified starch is agglomerated or compressed.

According to a particular embodiment, the carrier material is a mixture of modified starch and at least one maltodextrin, wherein the maltodextrin has a DE comprised between 10 and 20DE.

According to a particular embodiment, the carrier material is a mixture of modified starch and at least one maltodextrin, wherein the maltodextrin has a DE comprised between 17 and 20DE.

A maltodextrin or a blend of maltodextrins having different DE values can be used.

According to a particular embodiment, the modified starch is used in an amount comprised between 10 and 70%, preferably between 10 and 50%, preferably between 10 and 49%, more preferably between 30 and 49%, even more preferably between 30 and 40% and/or the hydrolyzed starch, preferably a maltodextrin, is used in an amount comprised between 30 and 90%, preferably between 50 and 90%, preferably between 51 and 90%, more preferably between 51 and 70%, even more preferably between 60 and 70% by weight based on the total weight of the carrier material.

According to a particular embodiment, the modified starch is used in an amount less than 50% based on the total weight of the carrier material.

According to a particular embodiment, the carrier material comprises:
between 30 and 40% of a modified starch, and
between 60 and 70% of a maltodextrin having a DE between 17 and 20DE.

According to a particular embodiment, the carrier material does not comprise a maltodextrin having a DE less than or equals to 6DE. Indeed, it has been shown that a particle comprising a carrier containing a maltodextrin having a DE greater than 6DE and a modified starch exhibits a high flavor loading.

According to an embodiment, the flavor particle according to the present invention may comprise an additional component preferably chosen in the group consisting of gums, proteins, small molecule surfactant, plant extract, saponins, plant-derived proteins, protein hydrolysates, citrus fiber, sugar beet fiber or mixtures thereof and preferably used in an amount comprised between 1 to 30 wt.%, preferably 5 to 20 wt.% and more preferably 10 to 20 wt.% (based on the total weight of the flavor particle).

The term “gums” has the normal meaning of the term to a person skilled in the art. Particular examples of gums comprise gum arabic, gum karaya, gum ghatti, gum tragacanth, okra gum, etc. The term “proteins” has the normal meaning of the term to a person skilled in the art. Particular examples of proteins comprise pea protein, soy protein, lentil proteins, chickpea protein, rice protein, potato protein, fava bean protein, mung bean protein, canola protein, etc. The term “small molecule surfactant” has the normal meaning of the term to a person skilled in the art. Particular examples of small molecule surfactants comprise quillaja saponins, yucca saponins, phospholipids, lecithin, lysolecithin, diacetyltartaric and fatty acid esters of glycerol (DATEM), citric acid esters of mono and diglycerides (CITREM), etc.

In a particular embodiment, the flavor particle comprises a lubricant. In another embodiment, the lubricant comprises a micellar surfactant like lecithin or a fatty acid ester (e.g., citric, tartaric, acetic), DATEM, CITREM or mixtures of the above. In a particular embodiment, the lubricant may be provided in an amount, by weight, up to about 5%, particularly about 0.2 up to about 5%, more particularly from about 0.8% up to about 2% and even more particularly from about 1 to 2% of the total weight of the flavor particle.

According to an embodiment, the carrier material comprises a low molecular weight carbohydrate to improve flavor stability against oxidation and evaporative loss during storage. The low molecular weight carbohydrate can be chosen in the group consisting of sucrose, glucose, lactose, maltose, fructose, ribose, dextrose, isomalt, sorbitol, mannitol, xylitol, lactitol, maltitol, pentatol, arabinose, glucose syrup, pentose, xylose, galactose, Trehalose ® and mixtures thereof and are used preferably between 1% and 10%, more preferably between 2% and 6% by weight based on the total weight of the flavor particle.

According to a particular embodiment, the carrier material does not comprise a yeast.

In a particular embodiment, the flavor particle may further comprise water.

It is understood that the flavor particle may comprise only such amount of water so that it is still in form of a solid particle and not in the form of a liquid.

In a particular embodiment, the flavor particle according to the present invention is a stable flavor particle. By “stable flavor particle” it is herein understood that the flavor particle is stable against loss of sensory performance at room temperature in dry environment for at least 12 months.

### Process for Preparing a Flavor Particle

Another object of the invention is a process for preparing an extruded particle, wherein it comprises the following steps:
a) mixing at least a carrier material and a plasticizer, preferably water, to form a mixture;
b) heating the mixture at a temperature sufficient to form a molten mass;
c) pumping the molten mass and pushing said molten mass through a static mixer;
d) extruding the melt through a die to form an extrudate;
e) cutting or crushing the extrudate to form an extruded particle,
wherein a flavor is added to the mixture in step a) and/or in the molten mass in step b).

According to a particular embodiment, the extruded particle obtained in step e) has a retained flavor of greater than or equals to 13%, particularly greater than 15% by weight based on the total weight of the particle.

In a particular embodiment, at the end of step e), the flavor particle comprises a flavor in an amount greater than 13 wt.% (based on the total weight of the flavor particle).

In a particular embodiment, at the end of step e), the flavor particle comprises a flavor in an amount of equal to or greater than 15 wt.% (based on the total weight of the flavor particle). In a particular embodiment, at the end of step e), the flavor particle comprises a flavor in an amount of equal to or less than 40 wt.% and particularly equal to or less than 30 wt.%, and more particularly equal to or less than 25 wt.% (based on the total weight of the flavor particle). In a particular embodiment, the flavor particle comprises the flavor in an amount of 13 to 40 wt.%, particularly between 13 to 30 wt.%, more particularly between 13 to 25 wt.% (based on the total weight of the flavor particle).

In a particular embodiment, at the end of step e), the flavor particle comprises a flavor in an amount between 13 to 20%, particularly between 13 to 15% wt.% (based on the total weight of the flavor particle).

In a particular embodiment, at the end of step e), the flavor particle comprises the flavor in an amount of 15 to 40 wt.%, particularly of 15 to 30 wt.% and more particularly of 15 to 25 wt.% (based on the total weight of the flavor particle).

The embodiments described above for the particle according to the invention also apply to the process according to the invention. This particularly applies to the carrier material, the flavor and the lubricant.

### Step A): Mixing at Least a Carrier Material and a Plasticizer

The carrier material of step a) can be any compound which can be readily processed through extrusion techniques to form a dry extruded solid.

In a particular embodiment, the carrier of step a) is practically neutral from a flavor point of view, i.e. that does not significantly alter the organoleptic properties of flavoring ingredients.

In a particular embodiment, the carrier of step a) is a solid carrier.

In a particular embodiment, the carrier of step a) is a biopolymer.

In a particular embodiment, the carrier of step a) is a food grade biopolymer.

In a particular embodiment, the carrier of step a) is a water-soluble food grade biopolymer.

In a particular embodiment, the carrier of step a) is a starch derivative, gums, fibers, polysaccharides, proteins, soluble flours or mixtures thereof.

The term “starch derivative” has the normal meaning of the term to a person skilled in the art. Starch derivatives are prepared by enzymatically, physically or chemically treating native starch to alter its properties. Particular examples of starch derivatives comprise maltodextrin, dextrin, resistant starch, hydroxypropylated starch, phosphate starch phosphate, octenylsuccinated starch, starch aluminium octenyl succinate, acetylated distarch phosphate, acetylated distarch adipate, acetylated distarch adipate, hydroxypropyl distarch phosphate and acetylated oxidized starch.

The term “gums” has the normal meaning of the term to a person skilled in the art. Gums can be derived from botanical sources, seaweeds, and bacteria fermentation. Particular examples of gums comprise gum arabic, gum tragacanth, gum karaya, gum ghatti, ocra gum, glucomannan, gellan gum, alginate, etc.

The term “fibers” has the normal meaning of the term to a person skilled in the art. They cannot be digested by human body’s enzymes. Particular examples of fibers comprise inulin, fructooligosaccharides, beta glucan, arabinogalactan, glucomannan, psyllium, soluble corn fiber etc.

The term “polysaccharides” has the normal meaning of the term to a person skilled in the art. Particular examples of polysaccharides comprise tamarind seed polysaccharide, soy polysaccharide, galactomannan, xyloglucan, carrageenan, pectin, curdlan, arabinan, arabinoglactan, etc.

The term “proteins” has the normal meaning of the term to a person skilled in the art. Paticular examples of proteins comprise pea protein, soy protein, lentil proteins, chickpea protein, rice protein, potato protein, fava bean protein, mung bean protein, canola protein, etc. The term “soluble flour” has the normal meaning of the term to a person skilled in the art. Soluble fours are flours with chemical, physical, or enzymatical treatment to increase their solubility and functionality. Particular examples of soluble flours comprise soluble rice flour, soluble brown rice flour, koji rice, etc.

According to an embodiment, the carrier material of step a) is the carrier material disclosed previously for the particles.

According to an embodiment, the carrier material comprises at least one modified starch and at least one hydrolyzed starch.

According to an embodiment, the carrier material comprises at least one hydrolyzed starch having a DE greater than 6DE, particularly greater than 10DE, more particularly greater than 17DE.

As mentioned previously, the DE value is a measure of the reducing equivalent of hydrolyzed starch, referenced to dextrose and expressed as a percentage (based on dry matter), determined by well-known procedures.

The dextrose equivalent DE is typically defined by the following relationship (H. Levine, L. Slade: “Water as a plasticizer: physico-chemical aspects of low moisture polymeric systems ”, in Water Science Reviews, 1988, Vol. 3, F. Franks (Ed.), pp. 79-185, Cambridge University Press, Cambridge, England)

$$\text{DE} = \left(18016\right) \text{/Mn}$$

wherein DE is Dextrose equivalent and wherein Mn is number average molecular weight.

The value Mn can be easily determined by the person skilled in the art, for example by using SEC Multi-Detector System.

As non-limiting example, the SEC instrument is Viscotek TDA305 max system (Malvern Instruments, Ltd, UK) with Viscotek Triple Detector Array (TDA) incorporating Refractive Index (RI), Light Scattering (LS), and Viscosity (VS) detectors. A typical method to determine Mn would be the following: the chromatographic system consists of A2000 (CLM3015) and A6000 (CLM3020) (300 mm L × 8.0 mm ID, Malvern Instruments Ltd.) put in series after a A7 guard column, with claimed exclusion limits for pullulan of 4 KDa and 2000 KDa respectively. The eluent is 0.1 M sodium nitrate with a flow rate of 0.4 mL/min. The injected volume is 100 µL with sample concentration of around 2 mg/mL. All measurements were conducted at 35° C. Reproducibility of the method is acceptable with standard deviation of 0.06% on retention volume at peak maximum for three consecutive injections.

The term “hydrolyzed starch” means an oligosaccharide-type material typically obtained by acid and / or enzymatic hydrolysis of starch, preferably corn starch.

According to a particular embodiment, the hydrolyzed starch is chosen in the group consisting of maltodextrins, dextrins, corn syrup and mixture thereof.

According to an embodiment, the carrier material comprises also a modified starch.

The term “modified starch” has the normal meaning of the term to a person skilled in the art, i.e a starch that has been physically modified (physical modification), enzymatically modified (enzymatic modification) or chemically modified (chemical modification).

“Physically modified starch” means a starch which has been subjected to a heat treatment in the presence of relatively small amounts of water or moisture. No other reagents are added to the starch during the heat treatment. The heat-treatment processes include heat-moisture and annealing treatments, both of which cause a physical modification of starch without any gelatinization.

“Enzymatically modified starch” means a starch which has been treated with one or more enzymes to modify its properties.

“Chemically modified starch” means a starch which has been reacted with reagents which have been added to the starch in order to form new covalent bonds between those molecules and the starch molecules.

Particular examples of modified starches comprise dextrin, hydroxypropylated starch, phosphate starch phosphate, octenylsuccinated starch, starch aluminium octenyl succinate, acetylated distarch phosphate, acetylated distarch adipate, acetylated distarch adipate, hydroxypropyl distarch phosphate and acetylated oxidized starch. Some non-limited examples include octenylsuccinic anhydride-modified starches such as MiraCap® by Tate & Lyle, Capsul® by Ingredion, EmCap® by Cargill, etc.

According to an embodiment, the modified starch is a chemically modified starch. The chemical modification can increase notably its hydrophobicity to act as stabilizer and emulsifier.

According to this embodiment, the chemically modified starch is chosen in the group consisting of Octenyl succinated starches.

According to a particular embodiment, the modified starch is not agglomerated or compressed.

According to an embodiment, the modified starch is agglomerated or compressed.

In a particular embodiment, the carrier material comprises a maltodextrin with a dextrose equivalent (DE) of about 1 to about 20.

In a particular embodiment, the maltodextrin is selected from a maltodextrin with a DE of about 10 up to about 18 DE.

In another embodiment, the carrier material comprises corn syrup with a DE from 21 up to 49. Any carrier material can be used that is made by the hydrolysis of starches from different origins such as, but not limited to, maize, wheat, potato or rice. In another embodiment, the carrier material is a hydrogenated starch hydrolysate (e.g., HSPolyols), fructose oligosacharides (e.g., but not limited to Inulin from Orafit), soluble fibers such as for example but not limited to Nutriose (Roquette) and pregelatinized starch.

In a particular embodiment, the carrier is mixture of a modified starch and a starch hydrolyzate having a DE greater than 6DE.

According to a particular embodiment, the carrier material is a mixture of modified starch and a maltodextrin, wherein the maltodextrin has a DE comprised between 10 and 20DE.

According to a particular embodiment, the carrier material is a mixture of modified starch and a maltodextrin, wherein the maltodextrin has a DE comprised between 17 and 20DE.

A maltodextrin or a blend of maltodextrins having different DE values can be used.

According to a particular embodiment, the modified starch is used in an amount comprised between 10 and 70%, preferably between 10 and 50%, preferably between 10 and 49%, more preferably between 30 and 49%, even more preferably between 30 and 40% and/or the hydrolyzed starch, preferably a maltodextrin, is used in an amount comprised between 30 and 90%, preferably between 50 and 90%, preferably between 51 and 90%, more preferably between 51 and 70%, even more preferably between 60 and 70% by weight based on the total weight of the carrier material.

According to a particular embodiment, the modified starch is used in an amount less than 50% based on the total weight of the carrier material.

According to a particular embodiment, the carrier material comprises:
between 30 and 40% of a modified starch, and
between 60 and 70% of a maltodextrin having a DE between 17 and 20DE.

According to a particular embodiment, the carrier material does not comprise a maltodextrin having a DE less than or equals to 6DE.

In a particular embodiment, a lubricant is provided in step a). While not wishing to be bound to any theory it is believed that the lubricant reduces shear and expansion of the molten mass at the exit die. In some embodiments, the lubricant may comprise a medium chain triglyceride (MCT). In another embodiment, the lubricant comprises a micellar surfactant like lecithin or a fatty acid ester (e.g., citric, tartaric, acetic), DATEM, CITREM or mixtures of the above. In a particular embodiment, the lubricant may be provided in an amount, by weight, up to about 5%, particularly about 0.2 up to about 5%, more particularly from about 0.8% up to about 2% and even more particularly from about 1 to 2% of the total weight of the mixture of step a).

According to a particular embodiment, a low molecular weight carbohydrate is added in step a), preferably chosen in the group consisting of sucrose, glucose, lactose, maltose, fructose, ribose, dextrose, isomalt, sorbitol, mannitol, xylitol, lactitol, maltitol, pentatol, arabinose, glucose syrup, pentose, xylose, galactose, Trehalose ®, and preferably provided in an amount, by weight between 1 and 10%, preferably 2 and 6% based on the total weight of the mixture of step a).

According to an embodiment, an additional component preferably chosen in the group consisting of gums, proteins, small molecule surfactant, plant extract, saponins, plant-derived proteins, protein hydrolysates, citrus fiber, sugar beet fiber or mixtures thereof is added in step a) and/or b), preferably in an amount comprised between 1 to 30 wt.%, preferably 5 to 20 wt.% and more preferably 10 to 20 wt.% (based on the total weight of the flavor particle).

The term “gums” has the normal meaning of the term to a person skilled in the art. Particular examples of gums comprise gum arabic, gum karaya, gum ghatti, gum tragacanth, okra gum, etc. The term “proteins” has the normal meaning of the term to a person skilled in the art. Particular examples of proteins comprise pea protein, soy protein, lentil proteins, chickpea protein, rice protein, potato protein, fava bean protein, mung bean protein, canola protein, etc. The term “small molecule surfactant” has the normal meaning of the term to a person skilled in the art. Particular examples of small molecule surfactants comprise quillaja saponins, yucca saponins, phospholipids, lecithin, lysolecithin, diacetyltartaric and fatty acid esters of glycerol (DATEM), citric acid esters of mono and diglycerides (CITREM), etc.

The glass transition temperature of the flavour and carrier mixture depends on the amount of plasticizer added to the initial mixture.

According to an embodiment, the glass transition temperature of the particle is substantially the same as the glass transition temperature of the mixture. This is attained by ensuring low or no loss of water.

According to this particular embodiment, a small amount of plasticizer, preferably water, is added to the mixture to guarantee that the glass transition temperature (T_{g}) of the resulting melt corresponds to and is substantially the same as that of the desired T_{g} value of the final product. In other words, contrary to other methods such as wet-granulation, the glass transition temperature of the mixture before extrusion has already the value required for the final product, which temperature is above room temperature and preferably above 40° C. so that the product can be stored at ambient temperature in the form of free-flowing particles. Consequently, this embodiment of the invention can dispense with the additional drying step following the extrusion, intended to remove water in order to increase T_{g} to an acceptable value, and therefore reduce the energy needs.

The proportions in which plasticizer is employed in the present invention therefore vary in a wide range of values which the skilled person is capable of adapting and choosing as a function of the nature of the carrier and the required T_{g} of the final product.

According to an embodiment, the plasticizer content is such that said mixture has a glass transition temperature T_{g} above room temperature.

The plasticizer is preferably water, however polyols such as glycerol, propylene glycol and there esters ( i.e.Triacetine) could be used as well. Small polar molecules can be used to lower the Tg, one may cite also organic acids (citric, maleic...), amino acids, mono and disaccharides (glucose, maltose fructose, sucrose...) and mixtures thereof.

Typically, the plasticizer is used in an amount comprised between 0.5 and 10%, preferably between 5 and 9%, based on the total weight of the mixture of step a).

### Step B): Heating the Mixture at a Temperature Sufficient to Form a Molten Mass

The mixture of step a) is then heated within an extruder, typically a single screw-extruder, a twin-screw extruder or a ram extruder, preferably a twin-screw extruder, at a temperature sufficient to form a molten mass.

The mixture of step a) is thus extruded in the extruder, which maintains the temperature of the mixture at a predetermined temperature which is comprised preferably between 90 and 130° C. This temperature is adapted to the system of the invention. Indeed, it has to be above the glass transition temperature of the carrier material in order to keep the mixture in the form of a molten mass. Pressure is also applied and adjusted to a value appropriate to maintain homogeneity of the melt. Typically, pressure values of up to 100 bar (10⁷ Pa) can be used depending on the size of the equipment.

According to the invention, a flavor is added to the mixture in step a) and/or in the molten mass in step b).

By “flavor or flavoring composition”, it is meant here a flavoring ingredient or a mixture of flavoring ingredients, solvents or adjuvants of current use for the preparation of a flavoring formulation, i.e. a particular mixture of ingredients which is intended to be added to an edible composition or chewable product to impart, improve or modify its organoleptic properties, in particular its flavor and/or taste. Flavoring ingredients are well known to a person skilled in the art and their nature does not warrant a detailed description here, which in any case would not be exhaustive, the skilled flavorist being able to select them on the basis of his general knowledge and according to the intended use or application and the organoleptic effect it is desired to achieve. Many of these flavoring ingredients are listed in reference texts such as in the book by S. Arctander, Perfume and Flavor Chemicals, 1969, Montclair, N.J., USA, or its more recent versions, or in other works of similar nature such as Fenaroli’s Handbook of Flavor Ingredients, 1975, CRC Press or Synthetic Food Adjuncts, 1947, by M. B. Jacobs, van Nostrand Co., Inc. Solvents and adjuvants of current use for the preparation of a flavoring formulation are also well known in the art.

In a particular embodiment, the flavor is a mint flavor. In a more particular embodiment, the mint is selected from the group consisting of peppermint and spearmint.

In a further embodiment, the flavor is a cooling agent or mixtures thereof.

In another embodiment, the flavor is a menthol flavor.

Flavors that are derived from or based on fruits where citric acid is the predominant, naturally-occurring acid include but are not limited to, for example, citrus fruits (e.g. lemon, lime), limonene, strawberry, orange, and pineapple. In one embodiment, the flavors food is lemon, lime or orange juice extracted directly from the fruit. Further embodiments of the flavor comprise the juice or liquid extracted from oranges, lemons, grapefruits, key limes, citrons, clementines, mandarins, tangerines, and any other citrus fruit, or variation or hybrid thereof. In a particular embodiment, the flavor comprises a liquid extracted or distilled from oranges, lemons, grapefruits, key limes, citrons, clementines, mandarins, tangerines, any other citrus fruit or variation or hybrid thereof, pomegranates, kiwifruits, watermelons, apples, bananas, blueberries, melons, ginger, bell peppers, cucumbers, passion fruits, mangos, pears, tomatoes, and strawberries.

In a particular embodiment, the flavor comprises a composition that comprises limonene, in a particular embodiment, the composition is a citrus that further comprises limonene.

In another particular embodiment, the flavor comprises a flavor selected from the group comprising strawberry, orange, lime, tropical, berry mix, and pineapple.

The phrase flavor includes not only flavors that impart or modify the smell of foods but include taste imparting or modifying ingredients. The latter do not necessarily have a taste or smell themselves but are capable of modifying the taste that other ingredients provides, for instance, salt enhancing ingredients, sweetness enhancing ingredients, umami enhancing ingredients, bitterness blocking ingredients and so on.

In a further embodiment, suitable sweetening components may be included in the particles described herein. In a particular embodiment, a sweetening component is selected from the group consisting of sugar (e.g., but not limited to sucrose), a stevia component (such as but not limited to stevioside or rebaudioside A), sodium cyclamate, aspartame, sucralose, sodium saccharine, and Acesulfam K or mixtures thereof.

According to an embodiment, the flavor is added in an amount greater than or equal to 13% by weight, particularly greater than 16.5% by weight.

According to an embodiment, the flavor is preferably added in an amount comprised between 5 and 25%, more preferably between 6 and 17% by weight.

When added in step a), the amount of flavor is added based on the total weight of the mixture.

When added in step b), the amount of flavor is added based on the total weight of the molten mass.

For a flavor is a solid form, the addition in step a) is more appropriate whereas for flavor in a liquid form, the addition in step b) is more appropriate.

According to a particular embodiment, the flavor is added in step a).

According to a particular embodiment, the flavor is added in step b).

The flavour is defined as mentioned previously for the flavour particles.

### Step C) Pumping the Flavored Molten Mass and Pushing Said Molten Mass Through a Static Mixer

In step c), the flavored molten mass is pumped and pushed through a static mixer. The pumping step can be carried out by using a gear pump, preferably a polymer gear pump, which allows to take the melt coming out of the extruder and pushing it through the static mixer. The gear pump can also avoid over pressure within the extruder.

Without being bound by any theory, it is believed that the static mixer finely distributes and disperses flavor droplets within the carrier material. The static mixer can also improve heat transfer with the barrel of the static mixer in order to avoid expansion of the melt whilst maintaining an optimal viscosity to promote efficient mixing.

However, the step d) of pumping can be carried out only thanks to the effect of the twin-screw extruder itself.

Without being bound by any theory, it is believed that the combination of a static mixer and a gear pump can improve the favor loading in the final particle.

### Steps D) and E): Extruding the Melt Through a Die to Form an Extrudate and Cutting or Crushing the Extrudate

In this particular embodiment, as the mixture comes to the die part of the extruder, the temperature is still above the glass transition temperature of the carrier. The extruder is equipped with a die face cutter and the mixture is thus cut at the temperature of the melt. Once cooled to ambient temperature, the already cut glassy material does not need to be shaped or dried in a spheroniser, fluid-bed dryer or other device, unlike what is the case with other processes where the molten carrier is cooled prior to the cutting. In a particular embodiment the surrounding air comprises chilled air.

During the extrusion process, the mixture is forced through a die having an orifice with a predetermined diameter which ranges typically from about 0.250 to 10 mm, more particularly from 0.250 to 3 mm, even more particularly from about 0.5 up to about 3.0 mm and more particularly from 0.7 to 3.0 mm. However, much larger diameters for the die are also possible.

In a particular embodiment, the powder may be extruded at a throughput of 10-25 kg/h through a 0.7 mm die hole using for example, but not limited to a Thermo Prism 16 mm twin-screw lab extruder or a Clextral BC21 equipped with a cutter knife in order to granulate the melt at the die exit. In another embodiment, the melt may be extruded for example as strands and allowed to cool and then cut or crushed.

In general, the extruder barrel consists of multiple barrel sections, which are independently temperature controlled. In one embodiment, the extruder comprises 2 to 9 heating and cooling zones with temperatures ranging from 20 to about 120° C.

The twin screws consist of a number of screw elements which slide onto a spline or shaft. The order and selection of screw elements is commonly referred to as the screw configuration and is an important consideration in achieving high flavor loads. The optimized screw configuration is described below and is ordered from the powder feed end, which is closest to the mechanical drive and continues to the die end, which is the product outlet.

Typically:

(i) the Feed Zone is located closest to powder feed end and includes the barrel with the powder feed port. It is typically composed of conveying screw elements, which are used to transfer powder into the extruder while allowing air to escape countercurrently through the powder feed port. The conveying elements may have constant or decreasing pitch. The temperatures of the barrels in this zone are typically controlled at 20° C. to 40° C. Liquids may be injected continuously into this zone.

(ii) the Melt Zone is downstream of the Feed Zone. It consists typically primarily of kneading blocks and conveying elements which are used to transfer mechanical energy into the product and melt the powder. Kneading blocks are selected to provide sufficient energy to melt the powder without overheating the product. The temperatures of the barrels in this zone are typically controlled at 60° C. to 120° C. Liquids are not typically injected in this zone.

(iii) the Mixing Zone is downstream of the Melt Zone. It consists of kneading blocks and mixing elements to disperse flavors and liquids into the melt, while minimizing heat generation. The temperatures of the barrels in this zone are typically controlled at 60° C. to 120° C. Liquids may be injected continuously into this zone.

(iv) the Pumping Zone is downstream of the Mixing Zone. It consists of mixing elements and conveying elements, which are used to generate sufficient pressure to force the melt through the die. The conveying elements may be of constant or decreasing pitch. The temperatures of the barrels in this zone are typically controlled at 60° C. to 120° C. Liquids are not typically injected in this zone. According to an embodiment, a gear pump is used in the pumping zone.

(v) the Static mixer Zone is downstream of the pumping zone. It is adjacent to the die. It consists of several precision engineering device in series for the continuous mixing of fluid materials without moving part. Type of static mixers, diameter and number of elements are properly sized to allow a fine dispersion of oil droplets within the melt whilst minimizing the pressure drop. It is fitted in a jacketed housing allowing temperature controlled at 60 to 120° C.

The rotation speed of the twin screws is optimized to provide sufficient mixing to disperse the flavor in the melt without overheating the product, which can cause the flavor and/or water to vaporize when the melt exits the extruder die. Specific mechanical energy is monitored and process parameters are adjusted to control the energy input.

The method of the present invention therefore requires an extruding apparatus (for example Clextral BC 21 twin-screw extruder) in which a static mixer and optionally a gear pump, preferably a polymeric gear pump has been added.

According to an embodiment, the ratio L_{E}/D_{E} of the extruder is comprised between 20 and 48, preferably between 24 and 36.

According to an embodiment, the ratio Ls/Ds of the static mixer is comprised between 6 and 24, preferably between 8 and 16.

L_{E}/D_{E} and Ls/Ds ratios are well-known from the person skilled in the art.

The L_{E}/D_{E} ratio of the extruder can be defined as the ratio of the length of the screw to its outside diameter.

The Ls/Ds ratio of the static mixer can be defined as the ratio of the length of the static mixer to its outside diameter.

According to an embodiment, a gear pump is inserted between the last barrel of the extruder and the static mixer in order to decouple the twin screw functions and the static mixer functions.

According to an embodiment, the static mixer is inserted between the last barrel of the extruder and the die plate and die assembly.

As non-limiting example of static mixer, one may cite for example KM Thermogenizer mixers, Primix mixer, Sulzer SMX or SMXS type.

As non-limiting example of gear pump, one may cite for example, Maag Entrex®, Cinox® or Therminox® pumps, Coreau Corextrude®, Eprotec melt-X.

### Flavored Consumer Product

Moreover, the present invention relates to a flavored consumer product comprising the flavor particle as described herein-above and, optionally, a flavor base consumer product.

The flavored consumer product may be a beverage or food product.

In a particular embodiment, the flavored consumer product may be suitable for conveying flavors to beverages, fluid dairy products, condiments, baked goods, frostings, bakery fillings, candy, chewing gum and other food products.

In a particular embodiment, the flavored consumer product is selected from the group consisting of: protein powders, protein drinks, protein bars, meat analogues, seafood analogues and savory goods. Meat analogues can include pork analogues, venison analogues, beef analogues, veal analogues, rabbit analogues, sausage analogues, deli meat analogues, ham analogues, salami analogues, pepperoni analogues, chicken analogues, turkey analogues, goose analogues, pheasant analogues, pigeon analogues, whale analogues, lamb analogues, goat analogues, donkey analogues, and squirrel analogues. Seafood analogues can include fish analogues, scallop analogues, shrimp analogues, crabmeat analogues, shellfish analogues, clam analogues, squid analogues, conch analogues, and sea pineapple analogues.

When the food product is a particulate or powdery food, the dry particles may easily be added thereto by dry-mixing. Typical food products are selected from the group consisting of an instant soup or sauce, a breakfast cereal, a powdered milk, a baby food, a powdered drink, a powdered chocolate drink, a spread, a powdered cereal drink, a chewing gum, an effervescent tablet, a cereal bar, and a chocolate bar. The powdered foods or drinks may be intended to be consumed after reconstitution of the product with water, milk and/or a juice, or another aqueous liquid.

Beverages include, without limitation, carbonated soft drinks, including cola, lemon-lime, root beer, heavy citrus (“dew type”), fruit flavored and cream sodas; powdered soft drinks, as well as liquid concentrates such as fountain syrups and cordials; coffee and coffee- based drinks, coffee substitutes and cereal-based beverages; teas, including dry mix products as well as ready-to-drink teas (herbal and tealeaf based); fruit and vegetable juices and juice flavored beverages as well as juice drinks, nectars, concentrates, punches and “ades”; sweetened and flavored waters, both carbonated and still; sport/energy/health drinks; alcoholic beverages plus alcohol-free and other low-alcohol products including beer and malt beverages, cider, and wines (still, sparkling, fortified wines and wine coolers); other beverages processed with heating (infusions, pasteurization, ultra-high temperature, ohmic heating or commercial aseptic sterilization) and hot-filled packaging; and cold-filled products made through filtration or other preservation techniques.

Fluid dairy products include, without limitation, non-frozen, partially frozen and frozen fluid dairy products such as, for example, milks, ice creams, sorbets and yogurts. Condiments include, without limitation, ketchup, mayonnaise, salad dressing, Worcestershire sauce, fruit-flavored sauce, chocolate sauce, tomato sauce, chili sauce, and mustard.

Baked goods include, without limitation, cakes, cookies, pastries, breads, donuts and the like.

Bakery fillings include, without limitation, low or neutral pH fillings, high, medium or low solids fillings, fruit or milk based (pudding type or mousse type) fillings, hot or cold make-up fillings and non-fat to full-fat fillings.

Suitable flavor base consumer products may be any foodstuff base, e.g. foods or beverages. Suitable foodstuff bases, e.g. foods or beverages, can be fried or not, as well as frozen or not, low fat or not, marinated, battered, chilled, dehydrated, instant, canned, reconstituted, retorted or preserved. Typical examples of said foodstuff bases include:
a seasonings or condiment, such as a stock, a savory cube, a powder mix, a flavored oil, a sauce (e.g. a relish, barbecue sauce, a dressing, a gravy or a sweet and/or sour sauce), a salad dressing or a mayonnaise;
a meat-based product, such as a poultry, beef or pork-based product, a seafood, surimi, or a fish sausage;
a soup, such as a clear soup, a cream soup, a chicken or beef soup or a tomato or asparagus soup;
a carbohydrate-based product, such as instant noodles, rice, pasta, potatoes flakes or fried, noodles, pizza, tortillas, wraps;
a dairy or fat product, such as a spread, a cheese, or regular or low fat margarine, a butter/margarine blend, a butter, a peanut butter, a shortening, a processed or flavored cheese;
a savory product, such as a snack, a biscuit (e.g. chips or crisps) or an egg product, a potato/tortilla chip, a microwave popcorn, nuts, a bretzel, a rice cake, a rice cracker, etc;
an imitation product, such as a dairy (e.g a reformed cheese made from oils, fats and thickeners) or seafood or meat (e.g. a vegetarian meat replacer, veggie burgers) analogue; or” a pet or animal food.

### EXAMPLES

The invention will now be described in further detail by way of the following examples.

### Example 1: Flavor Particles According to the Invention

A BC-21 co-rotating twin screw extruder (Clextral, Firminy France, L_{E}/D_{E} =32) equipped with a gear pump and a static mixer having a Ls/Ds ratio of 12 was used to encapsulate citrus flavor into a solid particulate form.

The static mixer is inserted between the last barrel of the extruder and the die plate and the gear pump is inserted between the last barrel of the extruder and the static mixer.

A blend was prepared by mixing the following ingredients:

| Ingredients | Weight (%) |
|---|---|
| Modified starch ¹⁾ | 25.9% |
| Maltodextrin 18DE ²⁾ | 48.1% |
| Diacetyltartaric and fatty acid esters of glycerol ³⁾ | 1.5% |
| Citrus flavor | 16.5% |
| Water | 8% |

1) Capsul® (Ingredion)
2) Glucidex® (Roquettes Frères)
3) DATEM

The extruder consists of 9 barrels with independent temperature control. The blend was fed into the extruder at a flow rate of 15 kg/hr. Barrel temperatures from feeder to die end ranged from 20 to 120° C. Screw speed was kept as 600 rpm. The melt was extruded through a die plate with 2.0 mm equivalent diameter holes. Die temperature was set at 95° C. After establishing steady-state extrusion conditions, the strands exiting the die were cut by means of rotating cutting blades/knives. Uniform extruded particles showed glass transition of 42.5° C. characterized by differential scanning calorimetry (DSC, Mettler Toledo). An oil content of 14.0% by weight was obtained in extruded particles with oil retention of 84%. Oil retention is express as the ratio of retained oil content to theoretical oil content.

### Comparative Example 2: Flavor Particles

Flavor particles were prepared according to the same process as defined in example 1 except that a static mixer and a gear pump were not used.

The obtained particles show an oil loading of only 8.8%.

1. A particle comprising:
a flavor, and
a carrier material characterized in that:
the carrier material comprises at least one modified starch and at least one hydrolyzed starch,
the hydrolyzed starch has a DE greater than 6DE, and
the particle comprises greater than or equals to 13% by weight of flavor based on the total weight of the particle.

2. The particle of claim 1, wherein the carrier material does not comprise a yeast.

3. The particle of claim 1, wherein the hydrolyzed starch is chosen from the group consisting of maltodextrins, dextrins, corn syrup and mixtures thereof.

4. The particle of claim 1, wherein the carrier material is a mixture of modified starch and at least one maltodextrin, wherein the maltodextrin has a DE comprised between 10 and 20DE.

5. The particle of claim 1, wherein the carrier material is a mixture of modified starch and at least one maltodextrin, wherein the maltodextrin has a DE comprised between 17 and 20DE.

6. The particle of claim 1, wherein the modified starch is used in an amount comprised between 30 and 40% and wherein the hydrolyzed starch is used in an amount comprised between 60 and 70% by weight based on the total weight of the carrier material.

7. The particle of claim 1, wherein the carrier material does not comprise a maltodextrin having a DE less than or equals to 6DE.

8. The particle of claim 1, wherein the particle comprises greater than 15% by weight of flavor.

9. The particle of claim 1, wherein the carrier material comprises a further carbohydrate chosen from the group consisting of sucrose, glucose, lactose, maltose, fructose, ribose, dextrose, isomalt, sorbitol, glucose syrup, mannitol, xylitol, lactitol, maltitol, pentatol, arabinose, pentose, xylose, galactose, Trehalose, and mixtures thereof.

10. The particle of claim 1, wherein the carrier material comprises:
between 30 and 40% of modified starch, and
between 60 and 70% of a maltodextrin having a DE between 17 and 20DE.

11. A process for preparing an extruded particle, the process comprising:
a) mixing at least a carrier material and a plasticizer to form a mixture;
b) heating the mixture at a temperature sufficient to form a molten mass;
c) pumping the molten mass and pushing said molten mass through a static mixer;
d) extruding the melt through a die to form an extrudate;
e) cutting or crushing the extrudate to form an extruded particle, wherein a flavor is added to the mixture in step a) and/or in the molten mass in step b).

12. The process according to claim 11, wherein the pumping step in step c) is carried out with a gear pump.

13. The process according to claim 11, wherein the flavor is added in an amount greater than or equal to 13% by weight.

14. The process according to claim 11, wherein the flavor is added in an amount comprised between 15 and 25% by weight.

15. A flavored consumer product comprising the flavor particle as claimed in claim 1 and, optionally, a flavor base consumer product.

16. The particle of claim 10, wherein the carrier material does not comprise a maltodextrin having a DE less than or equals to 6DE.

17. The particle of claim 10, wherein the particle comprises greater than 15% by weight of flavor.

18. The particle of claim 10, wherein the carrier material comprises a further carbohydrate chosen from the group consisting of sucrose, glucose, lactose, maltose, fructose, ribose, dextrose, isomalt, sorbitol, glucose syrup, mannitol, xylitol, lactitol, maltitol, pentatol, arabinose, pentose, xylose, galactose, Trehalose, and mixtures thereof.

19. A flavored consumer product comprising the flavor particle as claimed in claim 10 and, optionally, a flavor base consumer product.

20. The process according to claim 11, wherein the plasticizer is water.
